(19) United States
(12) Patent Application Publication
(10) Pub. No.: US 2008/0089309 A1
(43) Pub. Date: Apr. 17, 2008

(54) H-FDD scheduling in a wireless network

(76) Inventors: Rejean Groleau, Ville St-Laurent (CA); Robert Buchnajzer, Montreal (CA)

Correspondence Address: HOLLAND & KNIGHT LLP, 10 ST. JAMES AVENUE, 11th Floor, BOSTON, MA, 02116-3889, US

(21) Appl. No.: 11/581,823

(22) Filed: Oct. 17, 2006

(51) Int. Cl. H04B 7/216

(52) U.S. Cl. 370/342

(57) ABSTRACT

Methods and apparatus, including computer program products, for H-FDD scheduling in a wireless network. A computer-implemented method includes, in a wireless network including at least a base station and a subscriber station communicating over an air link, scheduling a scheduling frame, the scheduling frame partitioned in N consecutive groups indexed from 1 to N and comprising J air link frames in a downlink (DL) direction over the air link from the base station to the subscriber station and J air link frames in an uplink (UL) direction over the air link from the subscriber station to the base station. The method assigns data from a FDD SS to any group in a DL or UL direction. The method assigns data for H-FDD SS to any group when data flows only in the UL or DL direction and assigns data to a non-overlapping group for the DL direction and the UL direction when data flows in both directions.

### BACKGROUND

The present invention relates to wireless networks, and more particularly to H-FDD scheduling in a wireless network.

With cost reduction objectives in mind, some air link standards may allow the subscriber stations to operate in Half Frequency Division Duplex (H-FDD) mode.

### SUMMARY

The present invention provides methods and apparatus, including computer program products, for H-FDD scheduling in a wireless network.

In one aspect, the invention features a method including, in a wireless network including at least a base station and a subscriber station communicating over an air link, scheduling a scheduling frame, the scheduling frame partitioned in N consecutive groups indexed from 1 to N and comprising J air link frames in a downlink (DL) direction over the air link from the base station to the subscriber station and J air link frames in an uplink (UL) direction over the air link from the subscriber station to the base station.

In embodiments, the subscriber station can be a Frequency Division Duplex (FDD) subscriber station and the base station can be a FDD base station.

The subscriber station can be a Half Frequency Division Duplex (H-FDD) subscriber station and the base station can be a FDD base station.

Scheduling the scheduling frame can include assigning data to any group when data flows only in the UL direction or the DL direction and assigning data to non-overlapping groups for the DL direction and the UL direction when data flows in both directions.

Scheduling a scheduling frame can include using a minimum value for an allocation start time.

Scheduling a scheduling frame can include using a maximum value for an allocation start time, the UL allocation starting after a UL-MAP.

The scheduling frame can be scheduled one air link frame ahead of time and a UL-MAP can be sent one group ahead of time.

In another aspect, the invention features a wireless network including subscriber stations, and a base station, the base station including a media access controller (MAC) having a scheduler, the scheduler scheduling a scheduling frame, the scheduling frame partitioned in N consecutive groups indexed from 1 to N and including J air link frames in a downlink (DL) direction over an air link from the base station to a first subscriber station and J air link frames in an uplink (UL) direction over the air link from the first subscriber station to the base station.

In embodiments, the subscriber stations can be implemented as Half Frequency Division Duplex (H-FDD) subscriber stations and the base station can be implemented as a Frequency Division Duplex (FDD) base station.

The scheduler can use a minimum value for an allocation start time.

The scheduler can use a maximum value for an allocation start time, the UL allocation starting after a UL-MAP.

The scheduler can schedule the scheduling frame one air link frame ahead of time and a UL-MAP can be sent one group ahead of time.

The invention can be implemented to realize one or more of the following advantages.

A method relates to H-FDD scheduling where a Base Station/Access Point is FDD-capable and some or all subscriber stations are only H-FDD-capable, i.e., cannot simultaneously transmit and receive. To improve usage of the communication channel, the method insures that no given H-FDD station has to transmit and receive at the same time and that other H-FDD or FDD stations can use the air link while the given H-FDD station either transmits or receives.

A H-FDD scheduling method enables a simple way to schedule H-FDD subscriber stations from an FDD base station in a wireless network.

The H-FDD scheduling method insures ease of implementation and good scaling with the number of flows and subscriber stations.

The H-FDD scheduling method can simultaneously accommodate FDD subscriber stations enabling them to occupy the two groups.

Using the H-FDD scheduling method increases efficiency in air link usage, which leads to better usage of a scarce resource, i.e., frequency spectrum, and increased revenue for the operator by enabling a greater number of users.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary wireless network.

FIG. 2 is a scheduling diagram.

FIG. 3 is a scheduling diagram.

FIG. 4 is an exemplary list of variables.

FIG. 5 is exemplary pseudo code.

FIG. 6 is exemplary pseudo code.

FIG. 7 is an exemplary list of variables.

FIG. 8 is exemplary pseudo code.

FIG. 9 is exemplary pseudo code.

Like reference numbers and designations in the various drawings indicate like elements.

### DETAILED DESCRIPTION

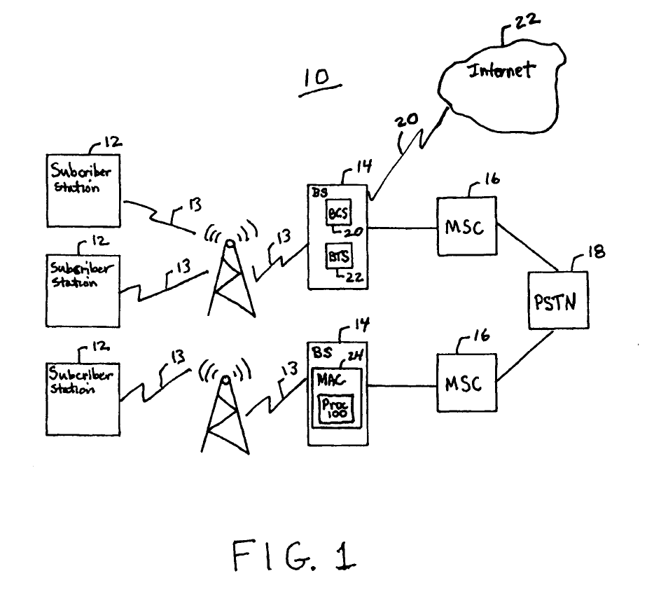

As shown in FIG. 1, an exemplary wireless network 10 is a hierarchical structure and includes mobile and/or fixed subscriber stations (SSs) 12 communicating over one or more air links 13 to one or more base stations (BS) 14 and one or more mobile switching centers (MSCs) 16. The wireless network 10 enables wireless (also referred to as cellular) subscribers to wander anywhere and remain connected to each other and to a Public Switched Telephone Network (PSTN) 18. Typically, BSs are connected to a MSC using land lines. Each MSC 16 is connected to a PSTN 18 main switching center.

Each MSC 16 performs telephony switching functions. The MSC 16 controls calls to and from other telephone and data systems. The MSC 16 can perform functions such as toll ticketing, network interfacing, common channel signaling, and so forth.

Each BS 14 performs most radio-related functions and typically includes a base station controller (BSC) 20 and a base transceiver station (BTS) 22. The BSC 20 provides all the control functions and physical links between the MSC 16 and BTS 22. The BSC 20 is a high-capacity switch that provides functions such as handover, cell configuration data, and control of radio frequency (RF) power levels in BTSs. In a typical configuration a group of BSCs are served by the MSC 16.

The BTS 22 handles the radio interface to the mobile stations 12. The BTS 22 is the radio equipment (i.e., transceivers and antennas) needed to service each cell in the wireless network 10. A group of BTSs is controlled by the BSC 20.

The BS 14 can include a connection 20 to the Internet 22 to enable high speed Internet data to a subscriber station 12.

Each BS 14 includes a media access controller (MAC) 24, each MAC 24 including a process 100 that handles scheduling between the BS 14 and SSs 12. As an example, an IEEE 802.16 MAC contains a scheduling module. Scheduling process 100 is stable under overload and over-subscription conditions, and enables the BS 14 to control Quality of Service (QoS) by balancing assignments among the needs of the SSs 12.

In IEEE 802.16 networks, UL-MAP is a message that defines uplink channel access and uplink data burst profiles. DL-MAP is a message that defines downlink data burst profiles. UL-MAP and DL-MAP are both transmitted in the beginning of each downlink frame.

In IEEE 802.16 networks, the Allocation Start Time (AST) determines when the transmission assignments in the UL-MAP start to take effect.

In one example, the SSs 12 of network 10 are implemented as Half Frequency Division Duplex (H-FDD) subscriber stations, while the base station 14 is implemented as a Frequency Division Duplex (FDD) base station. Process 100 enables H-FDD scheduling between the H-FDD SSs 12 from the FDD BS 14 and ensures ease of implementation and good scaling with a number of flows and of subscriber stations. When all the active flows in the network 10 are from a single H-FDD SS, process 100, in its simplest implementation, mirrors the efficiency of a Time Division Duplex (TDD) scheduling scheme. When two or more H-FDD SSs are active, air link 13 usage efficiency quickly raises. Simplicity and efficiency come at an expense of some added delay and jitter. Process 100 schedules two groups at a time, labeled group 1 and group 2. FDD SSs can be scheduled in any group, while the H-FDD SSs are randomly assigned a particular group. In one implementation, a downlink (DL) direction is scheduled first, then an uplink (UL) direction. DL refers to a transmission path from the BS 14 to a SS 12 and UL refers to a transmission path from the SS 12 to the BS 14.

Bandwidth over the air link 13 is a scarce commodity. Therefore, a great deal of attention must be paid to efficiency. Air link 13 packing efficiency depends on many variables, such as, for example, the number of SSs with traffic to be sent in a given frame, the length of the packets (i.e., a packet that has been encoded for transmission over the air link 13), the lengths of the air link frame, the number of FDD and H-FDD SSs, and so forth.

H-FDD scheduling attempts to maximize air link packing efficiency while maintaining simplicity of implementation. Simplicity of implementation includes minimizing processing time per packet and avoiding refusing a packet because of an H-FDD conflict. This is particularly important in real-time systems where the scheduling has to be completed within a given amount of time.

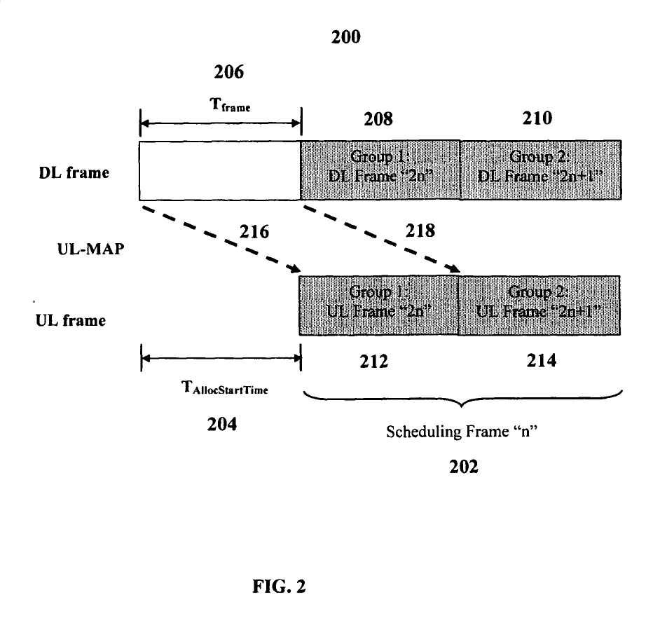

In general, process 100 schedules N groups at a time over the air link 13 in which N consecutive groups are referred to as a “scheduling frame.” For this scheduling frame, J air link frames are included in the DL direction and J air link frames in the UL direction. In one particular example, FIG. 2 illustrates a H-FDD scheduling diagram 200 that includes process 100 scheduling a scheduling frame “n” 202 for N=2 groups, with one group corresponding to an air link frame (i.e., J=2) and an allocation start time (T_{allocStartTime}) 204 equal to a frame period (T_{frame}) 206. More particularly, in a DL direction, two consecutive groups make up a scheduling frame, i.e., group 1, which corresponds to DL frame “2n” 208 and group 2, which corresponds to DL frame “2n+1” 210, and are scheduled over the air link 13. In a UL direction, two consecutive groups make up a scheduling frame, i.e., group 1, which corresponds to UL frame “2n” 212 and group 2, which corresponds to UL frame “2n+1” 214, and are scheduled by the UL-MAP 216, 218 over the air link 13 one frame ahead of time at T_{allocStartTime} 204.

In general, data from a FDD SS can be assigned to any group in a DL and UL direction. When using a H-FDD SS, data can be assigned to any group when data flows only in the UL direction or the DL direction. If data flows in both the UL direction and the DL direction, data are assigned to a non-overlapping group for the DL direction and the UL direction.

Allocation Start Time (AST) can affect the air link packing efficiency. Accordingly, another embodiment of process 100 is described below.

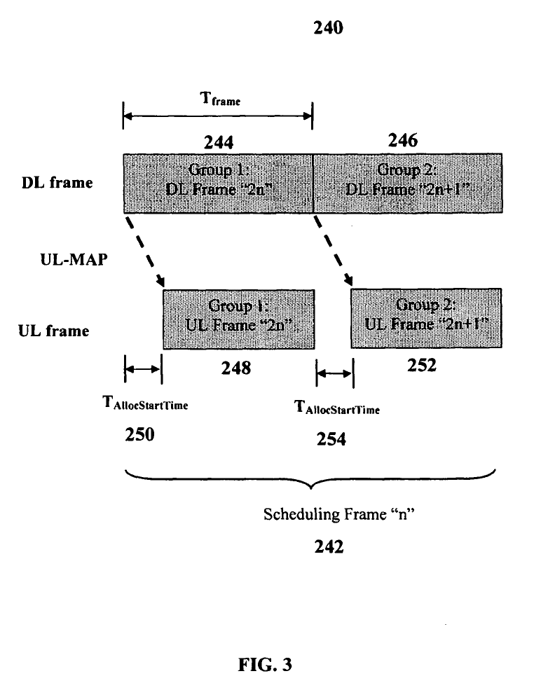

As shown in FIG. 3, a H-FDD scheduling diagram 240 of another possible embodiment of process 100 includes using a minimum value for the AST, e.g., 1 mS after the last symbol of the UL-MAP. For a 5 mS frame, this represents a loss of 20% of the air link.

More particularly, this embodiment of process 100 schedules over the air link 13 scheduling frame “n” 242 made of group 1 (244) and group 2 (246) in the DL direction starting at the beginning of the air link frame, and made of group 1 (248) in the UL direction starting at T_{allocStartTime} 250 and of group 2 (252) in the UL direction at T_{allocStartTime} 254, where T_{allocStartTime} is 1 mS.

The first embodiment of process 100 shown in FIG. 2 uses the maximum value for the AST, i.e., 1 frame, which implies a smaller loss of air link than in the second embodiment shown in FIG. 3 using a minimum value of AST, i.e. 1 mS. The first embodiment will however suffer from a larger latency and jitter.

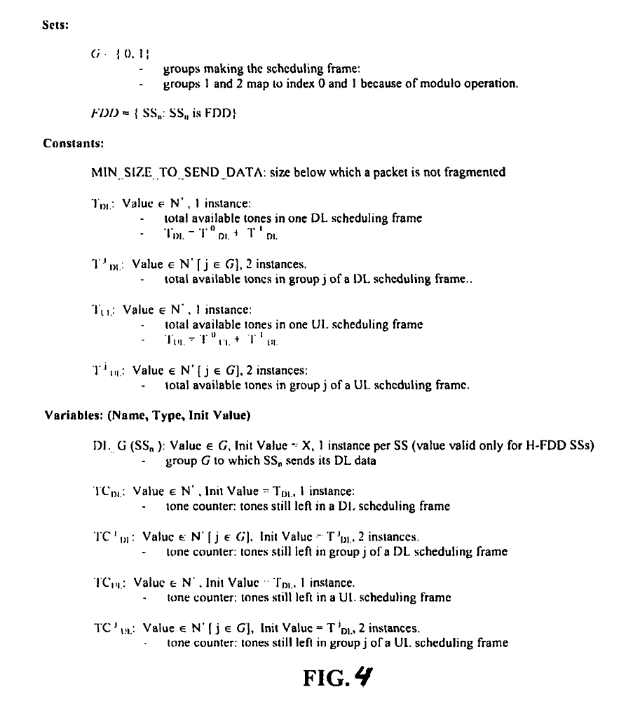

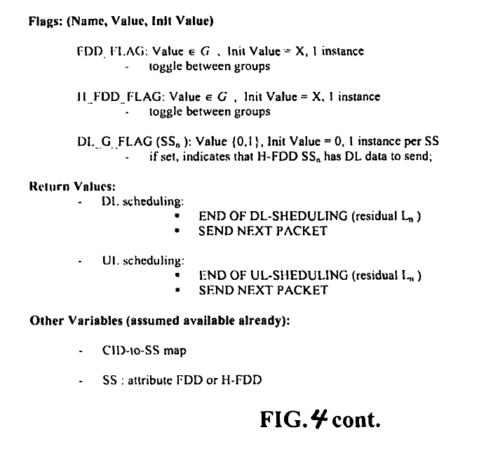

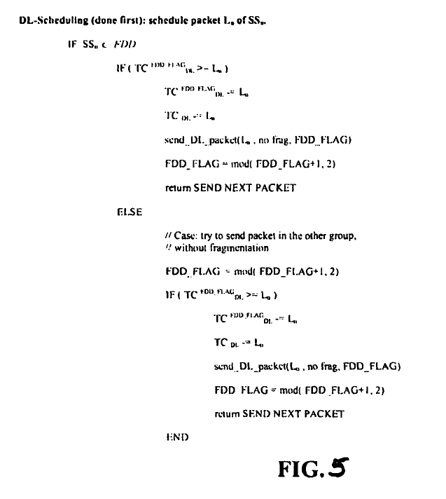

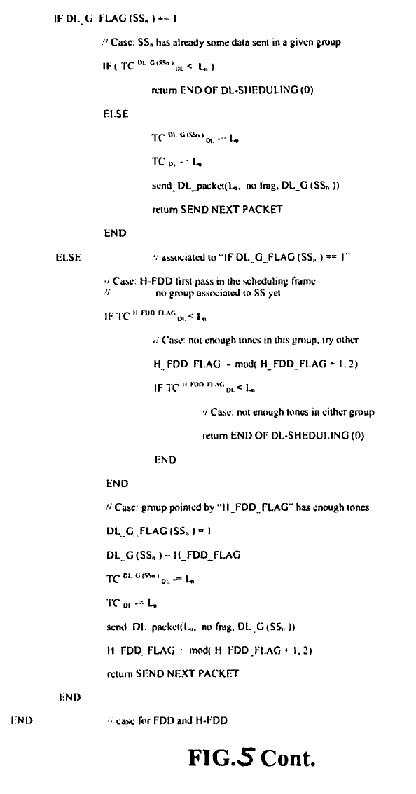

As shown in FIG. 4, exemplary variables used by the first embodiment include sets, constants, variables, flags, return values and other variables for the case N=2 and J=2. Initialization of these variables and flags at a start of each scheduled frame include:

TC_{DL}=T_{DL}=T⁰_{DL}+T¹_{DL}

TC^{j}_{DL}=T^{j}_{DL}:[jεG]

TC_{UL}=T_{UL}=T⁰_{UL}+T¹_{UL}

TC^{j}_{UL}=T^{j}_{UL}:[jεG]

DL_{—}G_FLAG(SSₙ)=0: for all SSs
where G is the set of group number: {1, 2}

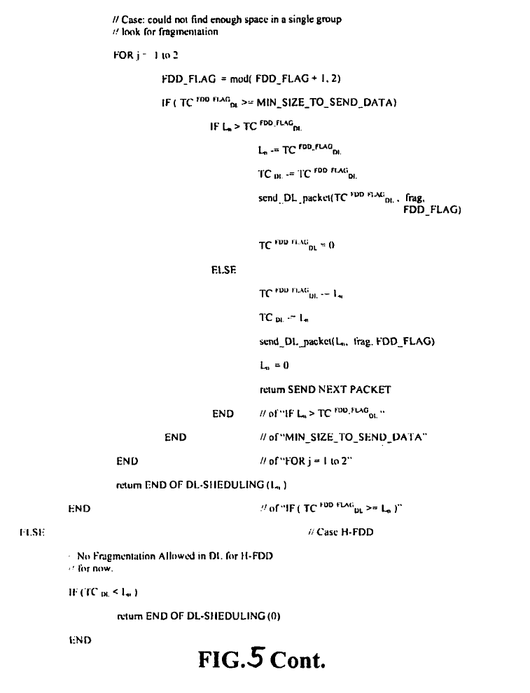

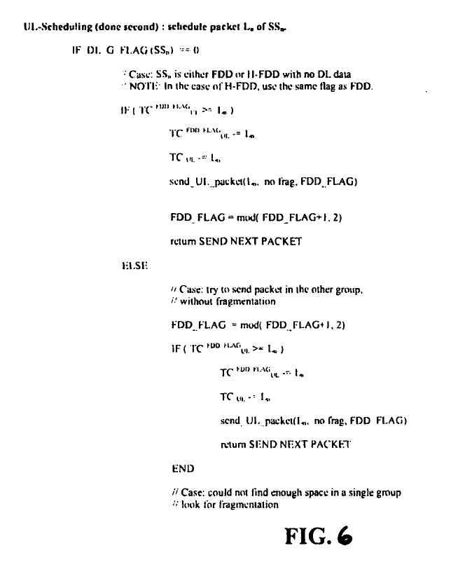

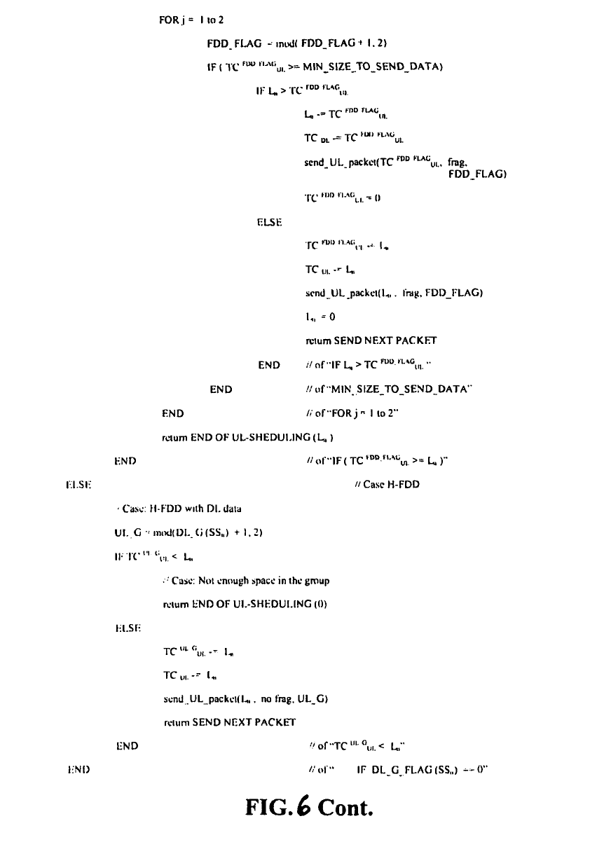

Exemplary pseudo-code for a DL frame for the first embodiment is shown in FIG. 5, while exemplary pseudo-code for a UL frame for the first embodiment is shown in FIG. 6.

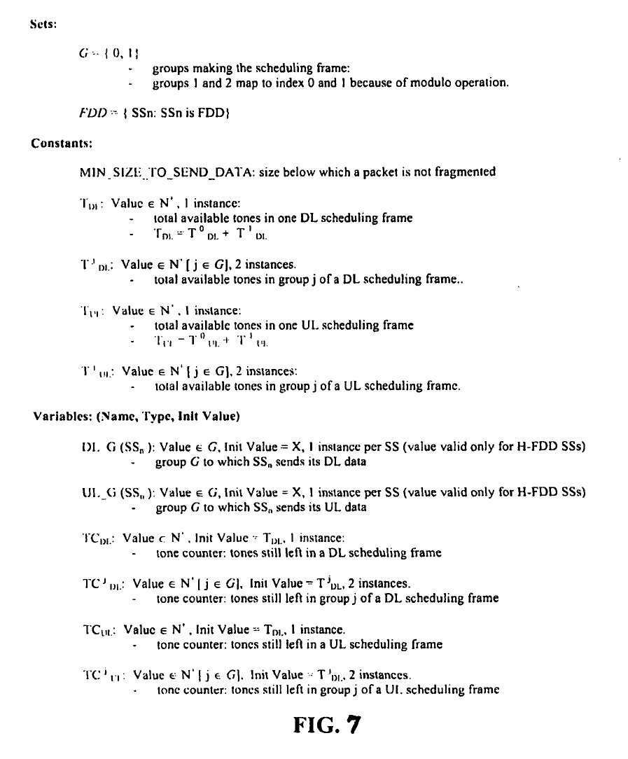

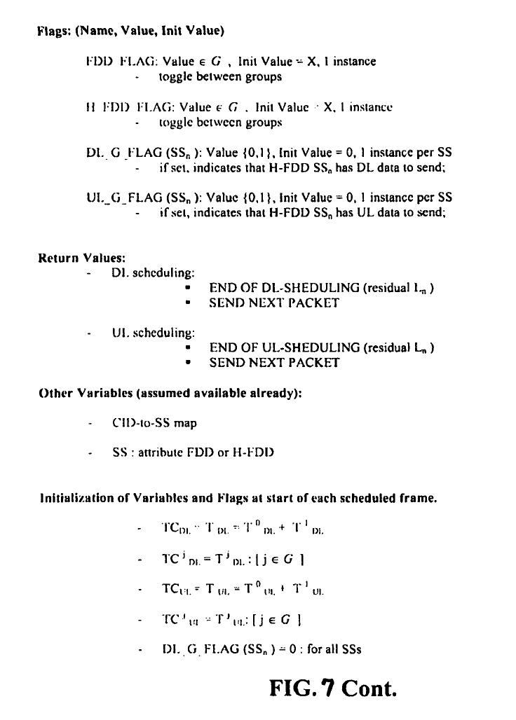

As shown in FIG. 7, exemplary variables used by the second embodiment include sets, constants, variables, flags, return values and other variables for the case N=2 and J=2. Initialization of these variables and flags at a start of each scheduled frame include:

TC_{DL}=T_{DL}=T⁰_{DL}+T¹_{DL}

TC^{j}_{DL}=T^{j}_{DL}:[jεG]

TC_{UL}=T_{UL}=T⁰_{UL}+T¹_{UL}

TC^{j}_{UL}=T^{j}_{UL}:[jεG]

DL_{—}G_FLAG(SSₙ)=0: for all SSs
where G is the set of group number: {1, 2}

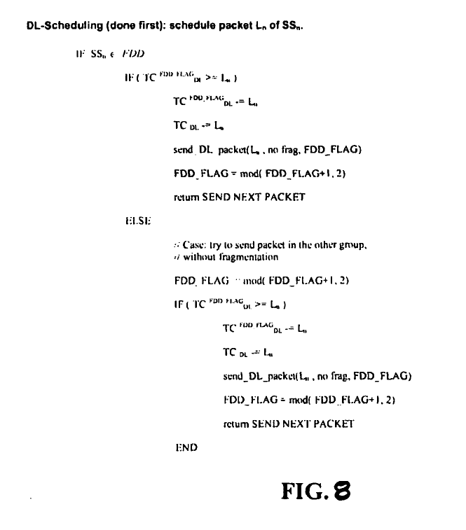

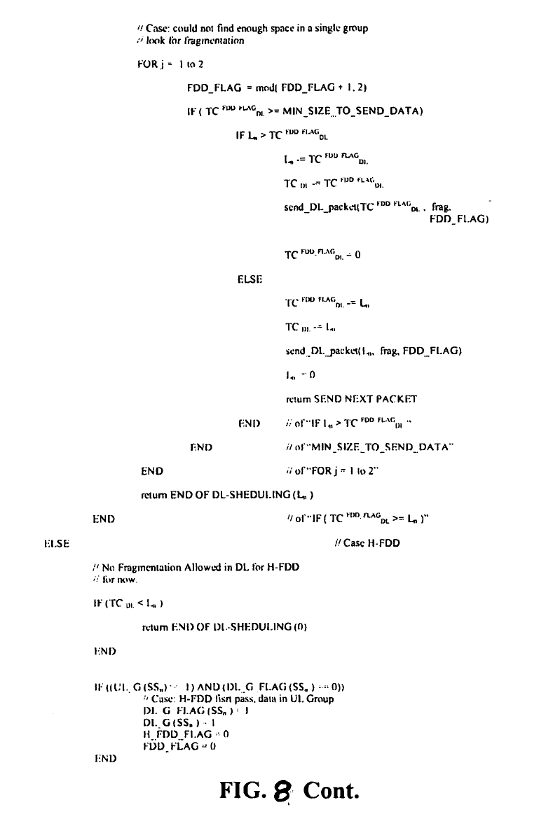

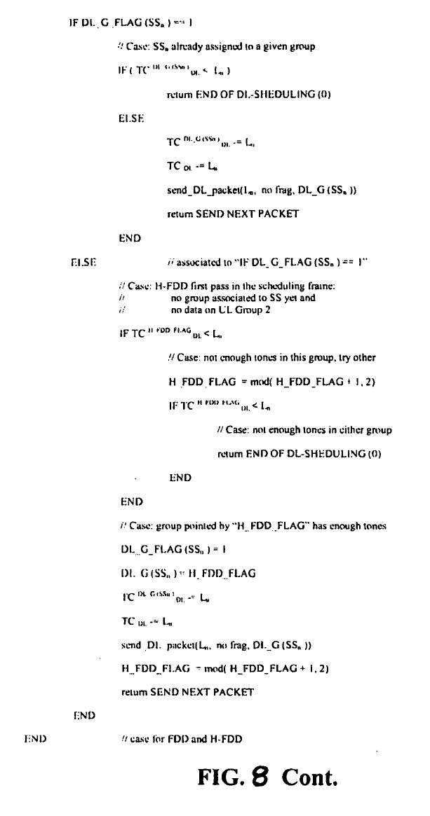

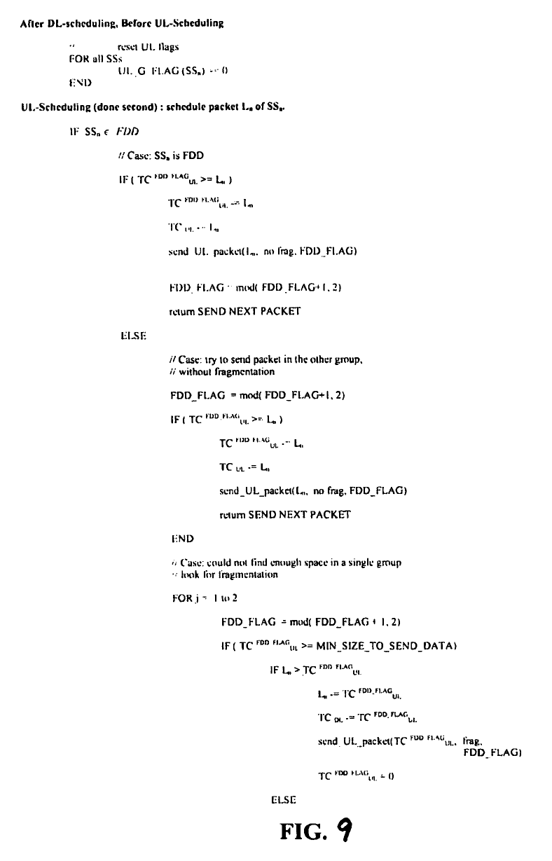

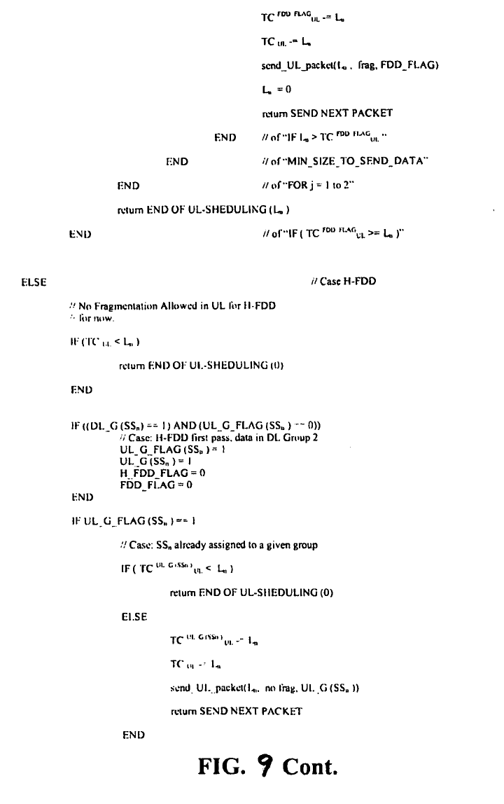

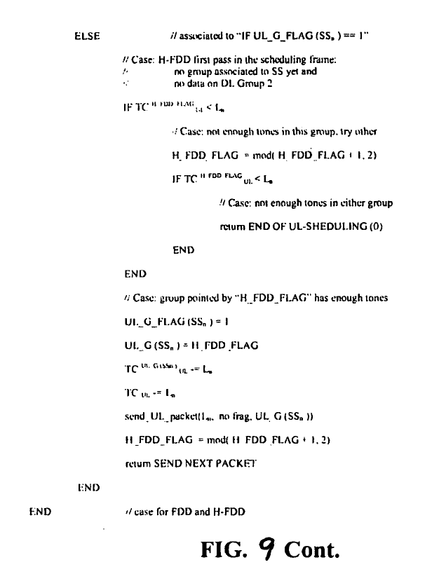

Exemplary pseudo-code for a DL frame for the second embodiment is shown in FIG. 8, while exemplary pseudo-code for a UL frame for the second embodiment is shown in FIG. 9.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The foregoing description of several methods and an embodiment of the invention have been presented for purposes of illustration. It is not intended to be exhaustive or to limit the invention to the precise steps and/or forms disclosed, and obviously many modifications and variations are possible in light of the above teaching. For example, the same method can be used to schedule two groups in one air link frame (i.e. N=2, J=1). The method can also be easily extended to improve air link usage efficiency by doing a second pass in the DL direction. The above modifications and extensions can be done to suit various needs in latency, jitter and processing time of particular applications. It is intended that the scope of the invention be defined by the claims appended hereto.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
in a wireless network including at least a base station and a subscriber station communicating over an air link, scheduling a scheduling frame, the scheduling frame partitioned in N consecutive groups indexed from 1 to N and comprising J air link frames in a downlink (DL) direction over the air link from the base station to the subscriber station and J air link frames in an uplink (UL) direction over the air link from the subscriber station to the base station.

2. The computer-implemented method of claim 1 wherein the subscriber station is a Frequency Division Duplex (FDD) subscriber station and the base station is a FDD base station.

3. The computer-implemented method of claim 1 wherein the subscriber station is a Half Frequency Division Duplex (H-FDD) subscriber station and the base station is a FDD base station.

4. The computer-implemented method of claim 3 wherein scheduling the scheduling frame comprises assigning data to any group when data flows only in the UL direction or the DL direction and assigning data to non-overlapping groups for the DL direction and the UL direction when data flows in both directions.

5. The computer-implemented method of claim 1 wherein scheduling a scheduling frame comprises using a minimum value for an allocation start time.

6. The computer-implemented method of claim 1 wherein scheduling a scheduling frame comprises using a maximum value for an allocation start time, the UL allocation starting after a UL-MAP.

7. The computer-implemented method of claim 1 wherein the scheduling frame is scheduled one air link frame ahead of time and a UL-MAP is sent one group ahead of time.

8. A wireless network comprising:
a plurality of subscriber stations; and
a base station, the base station comprising a media access controller having a scheduler, the scheduler scheduling a scheduling frame, the scheduling frame partitioned in N consecutive groups indexed from 1 to N and comprising J air link frames in a downlink (DL) direction over the an link from the base station to a first subscriber station and J air link frames in an uplink (UL) direction over the air link from the first subscriber station to the base station.

9. The network of claim 8 computer-implemented method of claim 1 wherein the plurality of subscriber stations are implemented as Half Frequency Division Duplex (H-FDD) subscriber stations and the base station is implemented as a Frequency Division Duplex (FDD) base station.

10. The network of claim 8 wherein the scheduler uses a minimum value for an allocation start time.

11. The network of claim 8 wherein scheduler uses a maximum value for an allocation start time, the UL allocation starting after a UL-MAP.

12. The network of claim 8 wherein the scheduler schedules the scheduling frame one air link frame ahead of time and a UL-MAP is sent one group ahead of time.

13. A computer program product, tangibly embodied in an information carrier, for H-FDD scheduling in a wireless network, the computer program product being operable to cause data processing apparatus to:
in a wireless network including at least a base station and a subscriber station communicating over an air link, schedule a scheduling frame, the scheduling frame partitioned in N consecutive groups indexed from 1 to N and comprising J air link frames in a downlink (DL) direction over the air link from the base station to the subscriber station and J air link frames in an uplink (UL) direction over the air link from the subscriber station to the base station.

14. The computer program product of claim 13 wherein the subscriber station is a Frequency Division Duplex (FDD) subscriber station and the base station is a FDD base station.

15. The computer program product of claim 13 wherein the subscriber station is a Half Frequency Division Duplex (H-FDD) subscriber station and the base station is a FDD base station.

16. The computer program product of claim 15 wherein scheduling the scheduling frame comprises assigning data to any group when data flows only in the UL direction or the DL direction and assigning data to non-overlapping groups for the DL direction and the UL direction when data flows in both directions.

17. The computer program product of claim 13 wherein scheduling a scheduling frame comprises using a minimum value for an allocation start time.

18. The computer program product of claim 13 wherein scheduling a scheduling frame comprises using a maximum value for an allocation start time, the UL allocation starting after a UL-MAP.

19. The computer program product of claim 13 wherein the scheduling frame is scheduled one air link frame ahead of time and a UL-MAP is sent one group ahead of time.
